(19) United States
(12) Patent Application Publication
(10) Pub. No.: US 2015/0274416 A1
(43) Pub. Date: Oct. 1, 2015

(54) Receptacle for Debris Collecting, Scooping and Trapping

(71) Applicants: Gualberto Garcia, North Hills, CA (US); Alfredo Sandoval, Canoga Park, CA (US)

(72) Inventors: Gualberto Garcia, North Hills, CA (US); Alfredo Sandoval, Canoga Park, CA (US)

(21) Appl. No.: 14/668,326

(22) Filed: Mar. 25, 2015

Related U.S. Application Data
(60) Provisional application No. 61/970,206, filed on Mar. 25, 2014.

(51) Int. Cl. B65F 1/02; B65F 1/16

(52) U.S. Cl. CPC B65F 1/02; B65F 1/16

(57) ABSTRACT

A receptacle for debris collecting, scooping and trapping having a side wall with an inner surface and an outer surface, an open upper section having a perimeter lip, and a lower section having a bottom end. Located adjacent the perimeter lip at the front of the receptacle is an outward extending first handle located on the bottom end at the rear of the receptacle is an inward extending second handle. Integrally attached to and extending outward from the perimeter lip is a protruding bi-directional ramp. When the receptacle is tipped downward, the protruding bi-directional ramp interfaces with the ground, thereby allowing debris to be directed over the bi-directional ramp into the receptacle. Also, the bi-directional ramp creates a barrier in the form of a hump that prevents debris within the receptacle from falling out of the receptacle.

### TECHNICAL FIELD

The invention generally pertains to refuse containers, and more particularly to a debris collecting receptacle having an integral bi-directional ramp that when the receptacle is tipped with its opening parallel to the ground, the bi-directional ramp can be used to quickly and easily direct debris into the receptacle, and to maintain the debris within the receptacle.

### BACKGROUND ART

The collection of refuse such as trash is firmly established in many countries, and is a current predominant effort in most developing countries. In a country such as the United States refuse includes organic matter such as debris that accumulates or derives from trees, bushes and other plants. Most people take pride in the appearance of their residence, and will either themselves maintain the foliage around their residence, or they will hire a gardener to perform the task(s). Businesses that have foliage also maintain it to present a positive and appealing appearance to customers, clients and other visitors.

One of the most common tasks is the collection of dead plant debris and other plant debris that has been cut or otherwise removed. This debris is typically collected to a central location and is often in the form of a pile of various plants debris. A person will then manually transfer die debris into a container or receptacle for removal by the local trash service.

It is frequently difficult to pick up the debris and place it into a container. Preferably, a person will pick up as much debris at one time as possible to reduce the number of times, this action must be repeated. Unfortunately, a large quantity of debris that is picked up at one time makes it difficult to manage, and it requires effort and skill to consistently place large quantities of debris in a container. Also, some of the debris is small and lightweight, so even a minimal breeze can blow the debris away before it can be placed into a container.

Some individuals, gardeners and landscapers have attempted to provide a solution to these problems. One of the most used solutions is to tip, a trash container, or trash can, on its side and then sweep or push the debris into the container/can. The problem with this method is that the container/can is usually round which makes it difficult to maintain the container/can in a desired position, and only provides a limited size opening into which the debris may be swept or pushed. As a result this method requires two people to perform it—one person to maintain the container/can in position, and the other person to sweep or push the debris in.

Obviously what is needed is a viable solution to the above problem. By providing a debris container or receptacle that includes a bi-directional ramp that allows the container/receptacle to be tipped on its side to the ground and then maintained in a single stable position. The bi-directional ramp would also provide a large opening into which the debris can be swept or pushed and, a barrier that prevents debris within the receptacle from falling out of the receptacle. A container/receptacle with this capability would allow a single person to quickly and easily dispose of even large quantities of organic or non-organic debris.

A search of the prior art did not disclose any literature or patents that read directly on the claims of the instant invention. However, the following U.S. patents are considered related:

| PATENT NO. | INVENTOR | ISSUED |
|---|---|---|
| 6,974,167 | Springs II | 13 Dec. 2005 |
| 7,131,552 | Simonson | 7 Nov. 2006 |
| 7,185,783 | Miller | 6 Mar. 2007 |
| 7,192,037 | Pena | 20 Mar. 2007 |
| 8,291,543 | McCoy et al | 23 Oct. 2012 |

The U.S. Pat. No. 6,974,167 discloses a pan for use in connection with a trash receptacle with or without a trash bag inserted into the receptacle. The pan has brackets formed to engage the rim of the receptacle's opening so that debris can be swept directly into the pan and ultimately deposited into the receptacle. The pan elevates the rim of the receptacle so that debris tends to slide toward the bottom of the receptacle. Once the trash receptacle is stood erect, the pan facilitates the moving of the debris easily into the container or bag.

The U.S. Pat. No. 7,131,552 discloses a trash collection arrangement for multiple use comprising a sweeping ramp leading to a disposable, contained bag. In one configuration a special shaped container is provided as part of the arrangement, while in a further model the sweeping ramp is employed with a wide range of available containers.

The U.S. Pat. No. 7,185,783 discloses outdoor and indoor debris receptacles that can be formed from molded plastic. The receptacles include an open upper end with a d-shaped configuration and a closed bottom end with a substantially circular bottom configuration. The receptacles can have a generally cylindrical shape and a flat side wall having a triangular tubular shape for allowing the receptacle to be laid on its side so that rakes and brooms can move debris into the d-shaped opening. At least one handle located on the apex of the d-shaped opening allows the container to be lifted to a vertical standing position.

The U.S. Pat. No. 7,192,037 discloses a lid assembly and method for removing articles from a floor. The lid assembly includes a lid assembly base structure, a fastening device for securing the lid assembly base structure to a storage cart, and a platform riser that forms a support platform at a distal end. The lid assembly further includes a collector arrangement that is pivotally attached to the support platform and includes a collection panel. The collection panel and the collector arrangement provide a method for gathering large quantities of articles from the floor and directing them entirely to a storage cart.

The U.S. Pat. No. 8,291,543 discloses an adapter apparatus that is installed on a pail to allow debris to be swept into the pail when the pail is resting on its side on a surface to be swept. A mounting section is included which is configured to be positioned over at least part of a lip of the pail and secured in place on the pail. A debris collector guide is attached to the mounting section, with the debris collector guide including a pair of sidewalls and a bottom section disposed intermediate to the side walls.

For background purposes and indicative of the art to which the invention relates, reference may be made to the following remaining patents found in the patent search.

| PATENT NO. | INVENTOR | ISSUED |
|---|---|---|
| D523,701 | Dodge et al | 27 Jun. 2006 |
| D651,780 | Grasteit | 3 Jan. 2012 |
| application Ser. No. 61/970,206 | Garcia | 25 Mar. 2014 |
| 20010045371 | Ordonez | 29 Nov. 2001 |

### DISCLOSURE OF THE INVENTION

In its basic design, the receptacle for debris collecting, scooping and trapping is comprised of:

a) a side wall having an inner surface and an outer surface,
b) an open upper section having a perimeter lip with an protruding bi-directional ramp that terminates at a horizontal lip,
c) a lower section having a bottom end with an inner surface and an outer surface,
d) a first handle that is integrally molded onto the side wall, the handle extends outward and is dimensioned to be gripped by a person's hand, and
e) a second handle that is integrally molded into the bottom end, the second handle is comprised of an inward extending cavity that is dimensioned to be gripped by a person's hand.

The receptacle for debris collecting, scooping and trapping is designed to be tipped/placed parallel to the ground, with the bi-directional ramp flat in a horizontal position. Once the receptacle is in place the receptacle will not shift its location or position, thereby allowing a single person to sweep, push or otherwise direct a quantity of organic or non-organic debris over the bi-directional ramp and into the receptacle. The protruding design of the bi-directional ramp will maintain the debris within the receptacle, even if/when the receptacle is tipped upward from the rear. Also, the bi-directional ramp creates a barrier in the form of a hump to prevent debris within the receptacle from falling out of the receptacle. Additionally the design of the bi-directional ramp, which protrudes outward, is a significant improvement over prior art designs. Previous, prior art receptacles and containers lay flat on the ground when in a tipped downward position. The protruding bi-directional ramp, along with the design of the receptacle's upper section, elevates the receptacle off the ground to rest on two points, and is not on the same plane as the ground, for increased stability. Further, when a person uses a broom or similar device with a prior art design to push or pull debris into those designs, the handle will typically hit the edge or lip of the container or receptacle before the debris can be pushed into the receptacle. When using a broom or other device with the instant receptacle, the handle of the broom will not hit any lip or edge until after the debris is inside the receptacle since the bi-directional ramp is angled upward when laid on the ground, and protrudes out from the opposite lip or edge, allowing the debris to be swept onto and over the bi-directional ramp and into the receptacle before the handle of any tool would come into contact with the perimeter lip.

In view of the above disclosure the primary object of the invention is to provide a receptacle for debris collecting, scooping and trapping that when the receptacle is tipped over, allows a single person to quickly and easily direct a quantity of debris over the protruding bi-directional ramp and into the receptacle. The receptacle also includes a proprietary handle that allows a person to lift the receptacle from the bottom end/rear to facilitate the emptying of any debris within the receptacle.

In addition to the primary object, it is also an object of the invention to provide a receptacle for debris collecting, scooping and trapping that:
is easy to use,
is lightweight,
is well-made and durable to provide years of use,
can be used to collect organic or non-organic debris,
can be used indoors or outdoors,
can be used in a “dust pan” manner to collect debris either with a broom or other device or using the receptacle to scoop debris,
is easy to transport and store, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic front view of a receptacle for debris collecting, scooping and trapping.

FIG. 2 is a right side elevational view of the receptacle.

FIG. 3 is a rear elevational view of the receptacle showing the location of a first handle.

FIG. 4 is a left side elevational view of the receptacle showing the location of a second handle.

FIG. 5 is a top plan view of the receptacle.

FIG. 6 is a bottom plan view of the receptacle.

FIG. 7 is an orthographic view of a person lifting the receptacle from the bottom end/rear and tipping the receptacle forward by use of the two handles.

FIG. 8 is an orthographic right side view of the receptacle showing a metal strip longitudinally extending along a protruding bi-directional ramp's lip.

FIG. 9 is a left side elevational view of the receptacle showing a press-fit lid.

### BEST MODE FOR CARRYING OUT THE INVENTION

The best mode for carrying out the invention is presented in terms that disclose a preferred embodiment of a receptacle for debris collecting, scooping and trapping (“the receptacle”) 10. The receptacle 10 is designed to facilitate the insertion of debris into the receptacle by use of a bi-directional ramp. When the receptacle is tipped downward the bi-directional ramp is utilized to direct debris into the receptacle. Also, the bi-directional ramp creates a barrier in the form of hump to prevent debris within the receptacle from falling out of the receptacle.

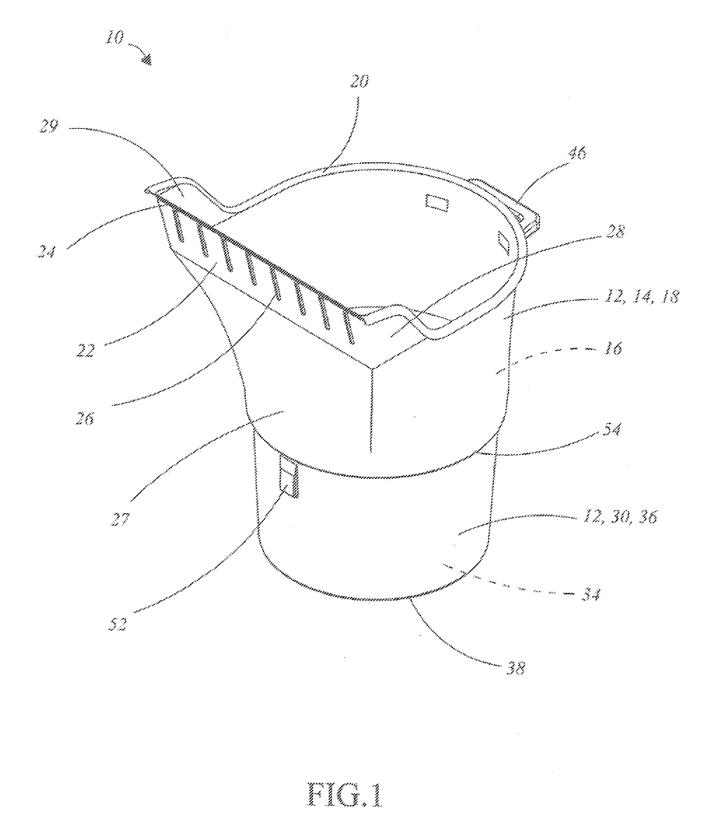

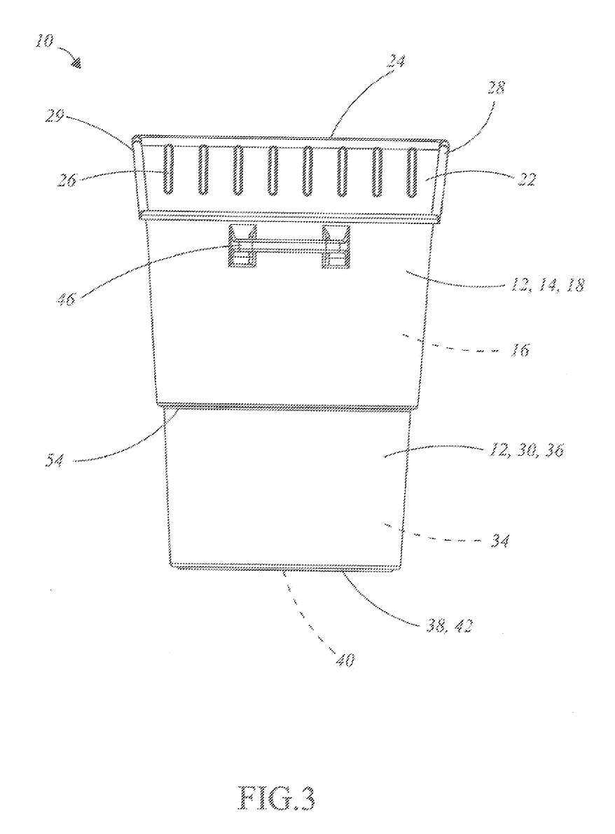

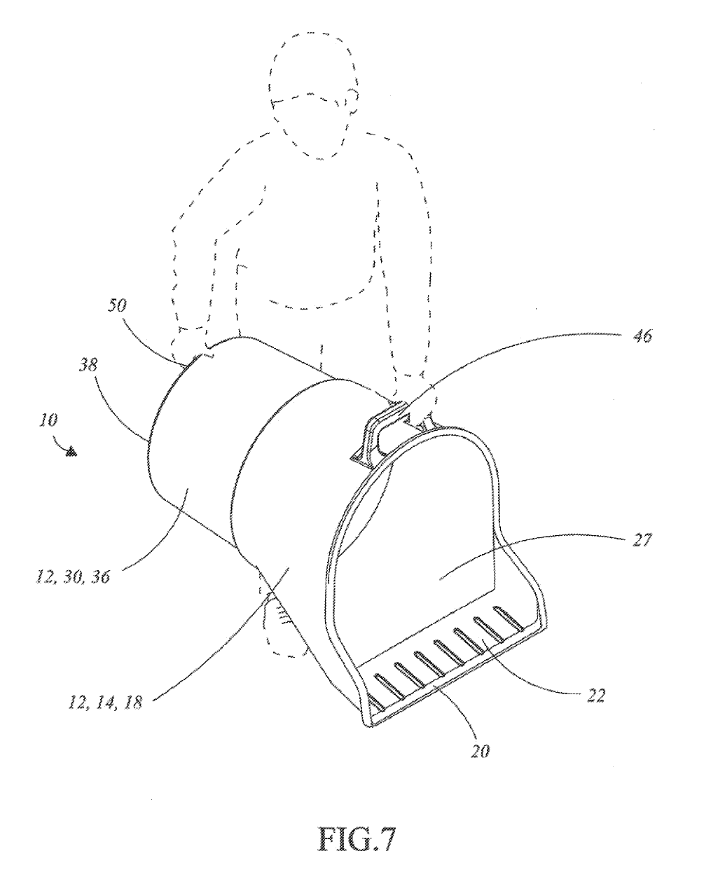

The receptacle 10, as shown in FIGS. 1-9, is comprised of the following major elements: a side wall 12 comprising an open upper section 14 with an protruding bi-directional ramp 22, a lower section 30 and a bottom end 38. The receptacle 10 can be made of plastic or metal, with molded plastic preferred.

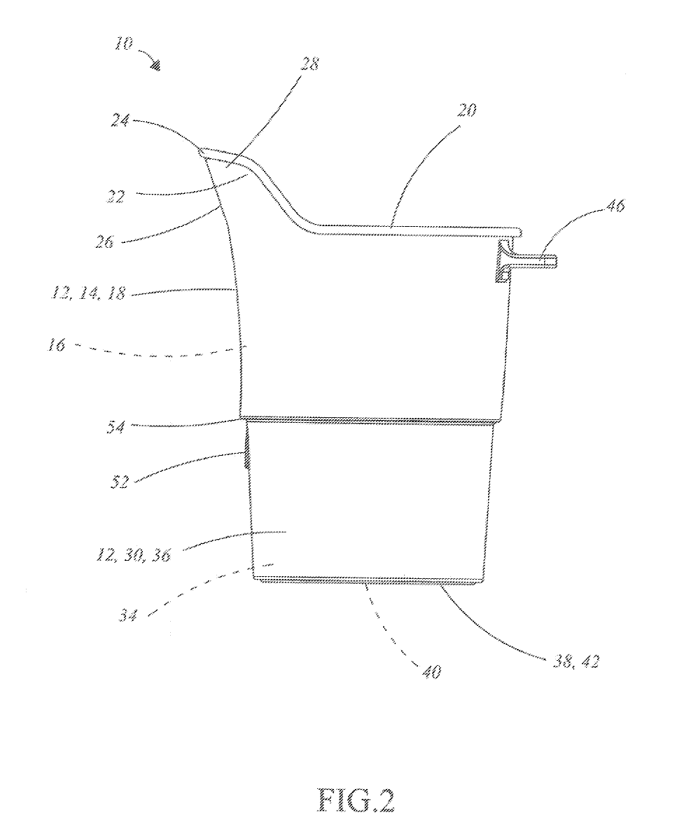

The side wall 12, as shown in FIGS. 1-9, comprises the open upper section 14 and the lower section 30. The open upper section 14 is substantially circular and has an inner surface 16 and an outer surface 18. Extending around the top of the open upper section 14 is a perimeter lip 20, as shown in FIGS. 1 and 2. Protruding from the open upper section 14 is the protruding bi-directional ramp 22. As shown in FIGS. 1-7, the protruding bi-directional ramp 22 has a horizontal lip 24 and the bi-directional ramp 22 follows an outward and upward curving trajectory from the open upper section 14 along the perimeter lip 20. The protruding bi-directional ramp's 22 downward angle is pronounced thereby insuring a sturdy and direct interface with the ground, with no gaps between the bi-directional ramp's lip and the ground, or any other flat surface, indoors or outdoors. The bi-directional ramp 22 has a first side wall 28 and a second side wall 29, as shown in FIGS. 1-4. The protruding bi-directional ramp 22 extends outward from the open upper section and the two sidewalls are substantially high, which facilitates the direction of debris over the bi-directional ramp 22 into the receptacle 10. This design is particularly effective when a rake or broom is utilized to push or pull debris over the bi-directional ramp 22, and when the receptacle 10 is tipped upward from the rear when debris is directed into the receptacle 10. The bi-directional ramp 22 has a flat trapezoidal shape 27, which traverses to the circular shape of the receptacle. As shown in FIGS. 1, 7 and 8, the trapezoidal shape 27 creates a “dust pan” design, which allows a greater amount of debris to be collected without spilling out. The design also allows a significant amount of debris including large and small particles to be collected in a single motion, and maintains debris within the receptacle 10 when transporting the debris to another container or receptacle. As shown in FIGS. 2, 4 and 9, the upper section 14 curves inward below the bi-directional ramp 22 to the substantial mid-point of the receptacle 10. The inward protruding shape of the upper section causes the receptacle 10 to substantially rest upon two surface points when the receptacle is in a downward position, parallel to the ground. The two surfaces points are the lip 24 of the bi-directional ramp 22 and a small area of the lower section 32 adjacent to the bottom end 38. When in the downward position, the bi-directional ramp's lip 24 is provided with extra durability and protection by a metal strip 56. To provide extra durability and protection to the area of the lower section 32 that is in contact with the ground, a skid plate (not shown) can be utilized. The skid plate, which is preferably made of metal, is attached to the area of the lower section 32 and extends approximately five to six inches along the lower section 32.

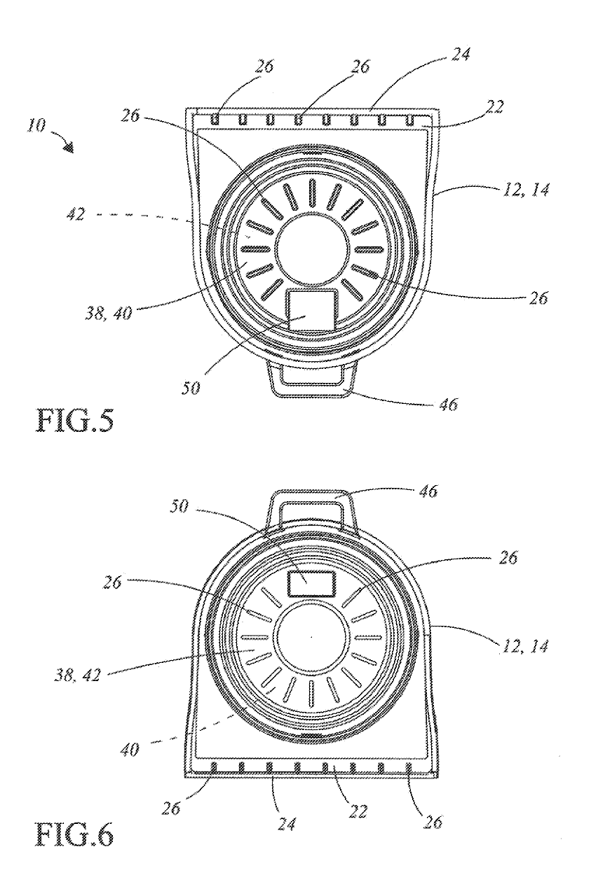

The lower section 30, as shown in FIGS. 1-4, tapers downward and has an inner surface 34, an outer surface 36, and a bottom end 38. As best shown in FIG. 6, the bottom end 38 is closed and has an inner surface 40 and an outer surface 42.

Integrally molded onto the side wall, at the rear of the receptacle when the receptacle is upright, opposite the bi-directional ramp 22 and adjacent the perimeter lip 20 is a first handle 46. As shown in FIGS. 1-6, the first handle 46 extends outward and is dimensioned to be gripped by a person's hand.

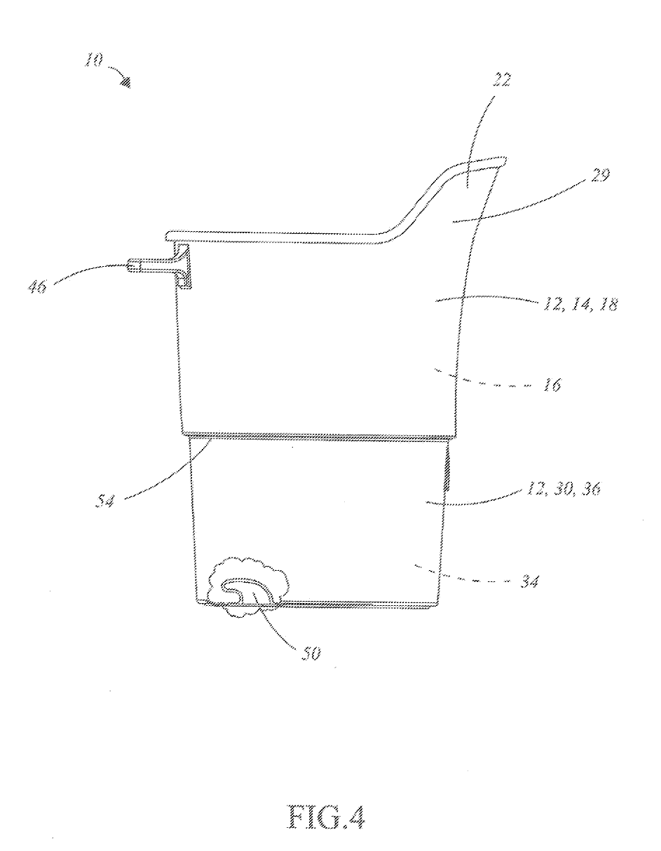

Integrally molded into the bottom end 38, at the rear of the receptacle adjacent the bottom end's perimeter, is a second handle 50. As shown in FIGS. 4 and 6, the second handle 50 consists of an inward extending cavity that is dimensioned to be gripped by a person's hand. The two handles 46,50 can be used simultaneously to allow a person to perform a bi-directional scooping motion with the receptacle to force debris over the bi-directional ramp into the receptacle: Also, the second handle 50 can be utilized as a guide when the bi-directional ramp's lip interfaces with the ground. The second handle 50 either alone or with the first handle 46, are used to push the receptacle 10, thereby collecting debris from various locations, for example a street curb gutter or side walk. The handles allow the receptacle to be lifted and held at an optimal position(s) during use, and to easily lift the receptacle to dump debris for the receptacle.

Separating the upper section 14 from the lower section 30 is a circumferential strip 54, as shown in FIGS. 1-4. The strip 54 extends inward, creating a ledge along the interior of the side wall 12. The circumferential strip 54 with its ledge along with the downward tapering design of the lower section, facilitates the nesting and stacking of multiple receptacles 10. A first receptacle is inserted into a second receptacle through the open upper section. Once inserted, the circumferential strip of the second receptacle interfaces with the ledge within the first receptacle, thus supporting the second receptacle within the first receptacle.

As shown in FIGS. 1 and 2, the receptacle 10 also includes a notch 52 that protrudes outward from the lower section 30 of the receptacle 10. The notch 52 is located below the bi-directional ramp 22 to provide a surface upon which a second receptacle can be nested and stacked within a first receptacle. The notch 52 also eliminates adherence as a result of friction, and a vacuum that is created when multiple nested and stacked receptacles are dislodged from each other.

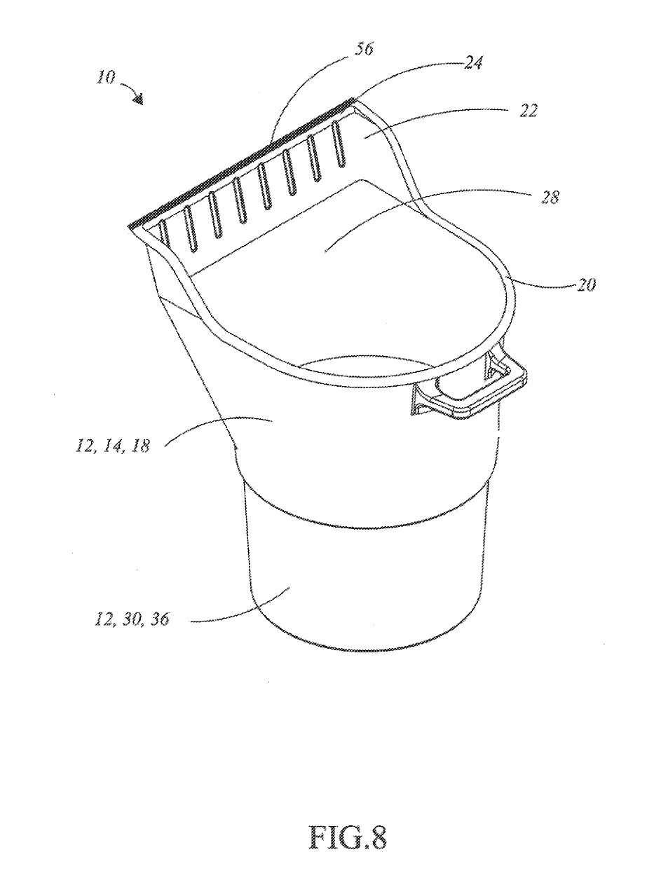

As previously disclosed, in order to provide increased strength and the useful life of the protruding bi-directional ramp's lip, a metal strip 56 can be located along the horizontal length of the lip 24. As shown in FIG. 8, the metal strip 56 increases the strength of the lip 24, where the bi-directional ramp 22 and its lip 24 interface with the ground, and where debris initially contacts the bi-directional ramp 22.

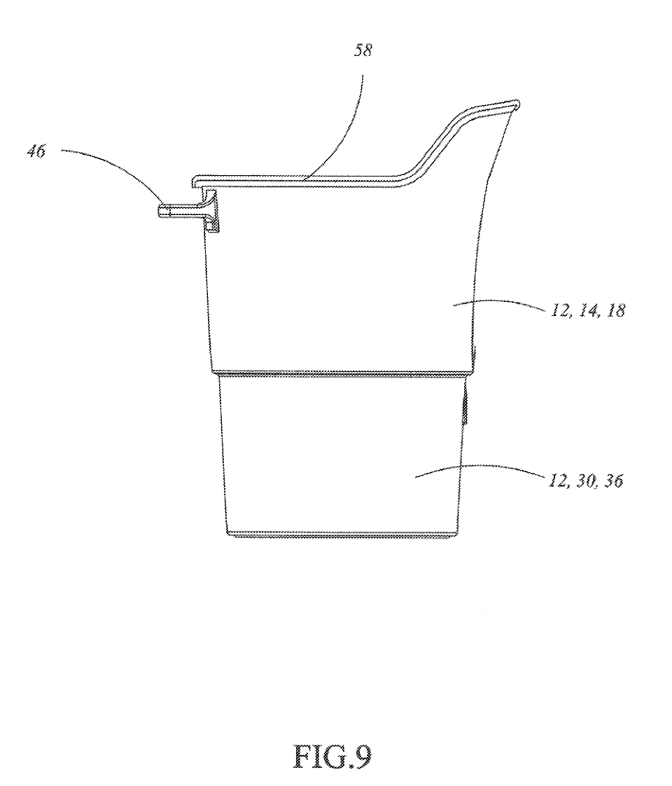

Additionally, to add to the functionally of the receptacle 10, a lid 58 can be attached to the receptacle. As shown in FIG. 9, the lid 58 is designed to press-fit along the perimeter lip 20 of the open upper section 14.

The use of the receptacle 10 is straightforward. When a quantity of debris is to be inserted into the receptacle 10, a person will tip the receptacle 10 downward or place the receptacle flat onto the ground. Once in a downward position, the protruding bi-directional ramp's lip 24 interfaces with the ground. The person will then direct the debris onto and over the bi-directional ramp into the receptacle. The benefits are that a single person can use the receptacle 10 to collect large and small debris, debris can be quickly and easily directed over the bi-directional ramp into the receptacle 10, and debris within the receptacle is trapped therein by a barrier created by a hump in the bi-directional ramp.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A receptacle for debris collecting, scooping and trapping comprising a side wall, an open upper section having a perimeter lip and a lower section having a bottom end, wherein integrally attached to and extending outward from said perimeter lip is a protruding bi-directional ramp, wherein when said receptacle is tipped downward said protruding bi-directional ramp interfaces with the ground, thereby allowing debris to be directed onto and over said bi-directional ramp into said receptacle, wherein said bi-directional ramp creates a barrier in the form of a hump to trap debris within said receptacle.

2. The receptacle for debris collecting, scooping and trapping as specified in claim 1 wherein said receptacle is made of molded plastic.

3. The receptacle for debris collecting, scooping and trapping as specified in claim 1 wherein said receptacle is made of metal.

4. The receptacle for debris collecting, scooping and trapping as specified in claim 1 wherein said receptacle is nestable and stackable.

5. The receptacle for debris collecting, scooping and trapping as specified in claim 1 wherein said upper section comprises a first handle that is integrally molded onto the side wall.

6. The receptacle for debris collecting, scooping and trapping as specified in claim 1 wherein said bottom end comprises a second handle that is integrally molded into said bottom end.

7. A receptacle for debris collecting, scooping and trapping comprising:
a) a side wall having:
(1) an open upper section having an inner surface, and outer surface and a perimeter lip with a protruding bi-directional ramp having a flat trapezoidal shape that terminates at a horizontal edge which continues from the perimeter lip, wherein said ramp comprises a first side wall and a second side wall, wherein the side walls facilitate the direction of debris into said receptacle, and prevent debris from escaping from said receptacle,
(2) a lower section having an inner surface and an outer surface, and a bottom end with an inner surface and an outer surface,
b) a first handle that is integrally molded onto said side wall, wherein said first handle extends outward and is dimensioned to be gripped by a person's hand, and
c) a second handle that is integrally molded into said bottom end, wherein said second handle is comprised of an inward extending cavity that is dimensioned to be gripped by a person's hand, wherein when said receptacle is tipped downward said protruding bi-directional ramp interfaces with the ground, thereby allowing debris to be directed onto and over said bi-directional ramp into said receptacle, and for facilitating the dumping of debris from said receptacle.

8. The receptacle for debris collecting, scooping and trapping as specified in claim 7 wherein said receptacle is made of molded plastic.

9. The receptacle for debris collecting, scooping and trapping as specified in claim 7 wherein said receptacle is made of metal.

10. The receptacle for debris collecting, scooping and trapping as specified in claim 7 wherein said lower section tapers downward.

11. A receptacle for debris collecting, scooping and trapping comprising:
a) a side wall having:
(1) an open upper section having an inner surface, an outer surface and a perimeter lip with an protruding bi-directional ramp that terminates at a horizontal edge which continues from the perimeter lip,
(2) a lower section that tapers downward having an inner surface and an outer surface, and a bottom end with an inner surface and an outer surface,
(3) an inward extending circumferential step that is located at the substantial midpoint of said side wall, and separates said upper section from said lower section, wherein said step provides a structural element in the form of a ledge within said receptacle, wherein the ledge facilitates the nesting and stacking of at least two receptacles,
b) a first handle that is integrally molded onto said side wall, wherein said first handle extends outward and is dimensioned to be gripped by a person's hand, and
c) a second handle that is integrally molded into said bottom end, wherein said second handle is comprised of an inward extending cavity that is dimensioned to be gripped by a person's hand, wherein when said receptacle is tipped downward said protruding bi-directional ramp interfaces with the ground, thereby allowing debris to be directed onto and over said bi-directional ramp into said receptacle.

12. The receptacle for debris collecting, scooping and trapping as specified in claim 11 wherein said receptacle is made of molded plastic.

13. The receptacle for debris collecting, scooping and trapping as specified in claim 11 wherein said receptacle is made of metal.

14. The receptacle for debris collecting, scooping and trapping as specified in claim 11 wherein said protruding bi-directional ramp is oriented to create an upward extending hump when said receptacle is in a downward tipped position, wherein the hump creates a barrier that maintains debris within said receptacle when said receptacle is in a downward positon and when receptacle is tipped upward from the bottom end during insertion of debris into said receptacle.

15. The receptacle for debris collecting, scooping and trapping as specified in claim 11 further comprising at least two ridges that are molded into and extend upward on said protruding bi-directional ramp, wherein each said ridge extends longitudinally perpendicular from said bi-directional ramp's lip, wherein said ridges facilitate the direction of debris over said bi-directional ramp into said receptacle, and increases the structural integrity of said bi-directional ramp.

16. The receptacle for debris collecting, scooping and trapping as specified in claim 11 further comprising at least a plurality of ridges that are molded into and extend downward on said bottom end, wherein each said ridge extends longitudinally outward in a circular orientation from the substantial center to the perimeter of said bottom end, wherein said ridges provide stability and reduce movement of said receptacle, when said receptacle is in an upright position, and increase the structural integrity of said bottom end.

17. The receptacle for debris collecting, scooping and trapping as specified in claim 11 further comprising a notch that protrudes outward from the lower section of said receptacle, wherein said notch is located below said bi-directional ramp to provide a surface upon which a second receptacle can be nested and stacked within a first receptacle, wherein said notch also eliminates adherence as a result of friction, and a vacuum that is created when multiple nested and stacked receptacles are dislodged from each other.

18. The receptacle for debris collecting, scooping and trapping as specified in claim 11 further comprising a metal strip that is located along the lip of said bi-directional ramp when said receptacle is made of plastic, wherein said metal strip provides a stronger horizontal section where said bi-directional ramp's lip interfaces with the ground and a stronger section where debris initially comes into contact with said bi-directional ramp.

19. The receptacle for debris collecting, scooping and trapping as specified in claim 11 further comprising a lid that encloses the open upper section.

20. The receptacle for debris collecting, scooping and trapping as specified in claim 18 wherein the lid is designed to be press-fit onto the lip of the open upper section and maintained thereon.
